(19) United States
(12) Patent Application Publication
(10) Pub. No.: US 2007/0226033 A1
(43) Pub. Date: Sep. 27, 2007

(54) Distributed cognitive aid method and system for scheduling and interactive task guidance

(76) Inventor: Edmund F. LoPresti, Pittsburgh, PA (US)

Correspondence Address: Debra M. Parrish, Esq., Suite 200, 615 Washington Rd., Pittsburgh, PA, 15228, US

(21) Appl. No.: 11/385,558

(22) Filed: Mar. 21, 2006

(51) Int. Cl. G06F 15/02

(52) U.S. Cl. 705/9

(57) ABSTRACT

The present invention discloses a device, system and method for providing scheduling assistance and interactive task guidance. The present invention allows multiple users to receive schedules and instructions remotely on any device with access to a central server. Multiple, authorized users can remotely access the schedule and instructions, permitting multiple individual entities to build instructions and schedules and who can be distinct from users. The present invention is comprised of at least one component and preferably a plurality of components that provide reminders, instructions, automated scheduling of multiple coincident and sequential tasks, integration of user feedback data with stored data, and a database.

### FIELD OF THE INVENTION

The present invention relates to a device, system and method for providing scheduling assistance and task guidance. More specifically, the present invention relates to an architecture in which information about an individual's or entity's daily activities are stored in a central location that can be accessed from at least one remote site to view or edit the schedule, receive reminders, and/or provide feedback about progress.

### BACKGROUND

Scheduling Support

A number of devices and systems have been developed to provide reminders of scheduled events. Typically, schedule data and the user interface exist on a single machine. For example, U.S. Pat. Nos. 6,104,674, 6,209,011, 6,374,276, 6,374,277 describe handheld computing devices with external notification systems. These devices and systems can provide information about scheduled tasks by cueing the user at an appropriate time. All information about a user's schedule is stored on a single device, typically a handheld computer or personal digital assistant (PDA), which also hosts the user interface. Unfortunately, these devices do not provide for remote access and are basic reminders that essentially function like an alarm clock, i.e., they have limited processing capabilities. These devices and systems provide a single cue to remind the user to perform a given task without providing a method for performing the task.

U.S. Pat. Nos. 6,018,289 and 6,587,036 describe similar systems specifically intended for reminding an individual to perform a plurality of periodically repeating tasks such as taking medication.

Some systems separate the schedule data from the user interface. For example, U.S. Pat. Nos. 6,064,977, 6,278,456, 6,658,427, and 6,735,294 describe means for providing scheduling information remotely over a telecommunications system such as the Internet or a telephone.

U.S. Pat. No. 6,225,920 describes a scheduling and reminder system specifically designed for assisting a person with a cognitive disability. The portable computer apparatus presents a plurality of first level virtual buttons on a display for selection by the individual suffering from a cognitive disability. Each first level virtual button corresponds to a different selectable domain or selection type. The first level virtual buttons are configured to correspond to the abilities and life needs of the individual user. When selected, a first level virtual button causes a category, sub-category, task, task element or content element to be presented. A hierarchical content structure, customized to the life needs and abilities of the individual user, is provided. A separate computer provides a means to develop the user's content and download it to the portable computer apparatus. Such devices have been implemented as the ISAAC system to assist people with cognitive disabilities in maintaining daily schedules.

U.S. Pat. No. 5,836,304 describes a computer system for therapeutically assisting in rehabilitation of patients having cognitive deficits. The system includes a base computer, a remotely located therapist computer adapted for remote modem communication with the base processor, and a portable computer that is adapted for mobile use by the patient and is docked to a base processor. The base, therapist and portable processors are programmed for uploading programming to the portable processor with prescribed patient activity information through the base processor and interface from the remote therapist processor for controlling the operation of the portable processor to communicate the prescribed information to the patient on a scheduled basis. The system is also programmed for downloading patient activity response information from the portable processor to the therapist processor for analysis.

Although the prior art provides some separation between schedule data and the user interface, the prior art does not provide interactive task guidance or the ability to automatically adapt the user's schedule or task sequence based on feedback provided by the user. Further, although systems exist which provide some of these features independently, until the present invention, no device or system integrates the various features with a distributed architecture in a single device or system.

Task Guidance

Some systems provide task guidance instead of scheduling assistance. U.S. Pat. Nos. 6,353,447, 6,537,073 and 6,790,044 describe methods and systems for establishing and using personal learning schedules. A study plan is established for a user based on the user's goals and constraints. The system guides the user through activities on a personalized basis. The method and system described in U.S. Pat. No. 6,353,447 monitors the user's progress in successfully completing those activities.

U.S. Pat. No. 5,813,863 describes an interactive behavior modification system. The system includes computer courseware and the means for presenting the courseware. The user interface may be a generic computer or a kiosk-type device; and the courseware can also be delivered over a network. The courseware includes a selectable progression of modules. While a user is navigating the modules, a tracking module tracks the user's decisions and other characteristics and alters the program content accordingly. This system is designed to deliver specific course content, rather than schedules of user-specific tasks, which may change daily and require feedback from a person who maintains the user's schedule.

U.S. Pat. No. 6,714,223 describes an interactive-type user interface device for a navigation system or the like in a car, which provides guidance for a particular task (navigation) and can support multiple scenarios.

Prior work in interactive task guidance for individuals with cognitive disabilities includes the COGORTH (from COGnition ORTHosis) programming language. Programs written in COGORTH display messages on a video screen. These messages can be used to provide information about how to complete an activity, recover from errors or interruptions, and perform multiple activities simultaneously (Kirsch, Levine, Fallon-Krueger, & Jaros 1987; Kirsch, Levine, Lajiness-O'Neill, & Schnyder 1992). More recently, an existing e-mail and scheduling application (Groupwise c) is used to develop a prototype messaging system that is modifiable in real-time (Kirsch, Shenton, & Rowan 2004). Specifically, Groupwise c is used to send alphanumeric pages to a person with a traumatic brain injury with reminder cues.

Task guidance for individuals with cognitive disabilities has been implemented on commercially handheld computers (Davies et al. 2004). The Pocket Coach and Pocket Compass provide audio, visual, and text cues to guide people through everyday tasks. These systems are implemented for a particular handheld computer platform and do not use a distributed architecture. They also do not provide dynamic scheduling assistance.

Others have proposed combining the concept of task guidance with the separation of task data and the user interface (Thöne-Otto, Walther, and Schulze 2003). This system uses a distributed architecture to provide task guidance to individuals with cognitive disabilities.

Although these systems provide task guidance, and some (Thöne-Otto, Walther, and Schulze 2003) also provide for separation of the task data and the user interface, they have a limited ability to dynamically adjust the user's schedule or instruction set. The education systems (U.S. Pat. Nos. 5,813,863, 6,353,447, 6,537,073 and 6,790,044) can automatically generate a lesson plan or course content, but they do not dynamically revise the schedule or lesson plans based on user feedback.

Adaptive Planning

U.S. Pat. Nos. 6,047,260 and 6,381,580 describe intelligent planning and calendaring devices with cueing feature and floating tasks. These systems can adjust an individual's schedule in response to changes (e.g., a scheduled appointment taking excessive time or an appointment being cancelled). These inventions have been implemented as a Planning and Executive Assistant and Training system. However, this system does not separate the schedule data from the user interface, the system is contained on a single device, and no task guidance is provided.

Software has been developed to provide intelligent scheduling, particularly of automated systems. The Adversarial Planner (Elsaesser & MacMillan 1991) provides for dynamic re-scheduling to promote efficient use of resources. Metrica, Inc. developed a planning assistant for NASA astronauts (Schreckenghost, et al., 2003) that aids users in defining activities and building plans using an automated planner and that provides for remote access to these plans. The RAP System (Firby 1999) allows for dynamic selection of steps to achieve defined goals. Neither system assumes a particular user interface and both are typically used in automated systems such as robots.

U.S. Pat. No. 6,606,304 describes a data and object monitoring and response system comprising a three-tier infrastructure for optimization of interoperability and task specific adaptability. This and similar layered architectures (Bonasso, et al., 1997) have been used for monitoring and coordinating mobile robots and crew space systems (Bonasso, et al., 2003; Schreckenghost, et al., 1998). The three-tier approach has been used to track humans performing tasks, specifically astronauts performing procedures, (Bonasso, Kortenkamp, and Whitney, 1997) but does not provide instructional assistance to humans integrated with task tracking.

This review of prior art shows that past inventions have addressed scheduling assistance, distributed systems, interactive task guidance, and adaptive planning. Although neuropsychologists have recognized the importance of interactive task guidance, adaptive planning, and scheduling assistance, the computational demands of these features and the sociological environment in which a cognitive assistant might be used have prevented the development of a practical method, system and device. Thus, despite the long-felt unmet need, until the present invention, no system has combined each of these four capabilities in the context of a single cohesive system.

### SUMMARY OF THE INVENTION

The present invention is a system, device, and method that provide scheduling assistance, task guidance and intelligent and automatic adjustment of the schedule and the steps of individual tasks. To overcome the limited processing capabilities and memory of existing handheld devices, the invention uses a distributed architecture. This distributed architecture also enables multiple users to access and edit schedules and instructions. Such multi-user access is particularly advantageous when cognitive limitations due to injury, aging, workload, or task complexity, prevent users from constructing their own schedules and instructions. Automated schedule management occurs on a central server. Users receive instructions remotely on any device with access to the server. For example, in one preferred embodiment, the server is connected to the Internet and a first user receives instructions on either an Internet-enabled computer, PDA, or cell phone. Similarly, a second user can edit schedules from any device with access to the server. The second user may be the same or a different user than the first user receiving reminders. In one preferred embodiment and application, the schedule is edited by a second user, e.g., a rehabilitation professional serving someone with a cognitive disability. The first user is the individual receiving reminders.

The distributed architecture supports interactive communication with first and second users. In addition to providing reminders to a first user, the system may elicit feedback from the first user to inform the first user about changes in plans if obstacles arise to performing a task. Second users will be remotely able to edit the schedule and monitor the first user's progress to discern difficulties and successes in completing activities. The second user can be informed of the first user's progress through user-initiated interaction (a second user chooses to access the schedule) or system-initiated interaction (the system alerts a second user of an emergency situation).

The present invention has at least one of the following components and preferably comprises a plurality of such components:

A first component, herein named an Activity Assistant, provides reminders to a first user. The Activity Assistant leads a first user through a daily schedule and assists the first user in following detailed instructions to accomplish activities on this schedule.

A second component, herein named a Design Assistant, allows a second user to define the steps for performing an activity and to create a schedule consisting of multiple activities.

A third component, herein named a Cognition Manager, is responsible for (1) building a schedule based on information supplied by a second user and updating it when a first user cannot meet it, and (2) monitoring and updating the instructions presented to a first user (preferably through the Activity Assistant) based on the stored schedule and the feedback provided by a first user during activity execution.

A fourth component, herein named an Information Server, that hosts a database that contains all the information about the schedule and activity instructions, provides information to at least one of the components and preferably all the components, and receives information from at least one component and preferably a plurality of components.

The Cognition Manager comprises a Schedule Supervisor that manages a first user's schedule, and an Instruction Sequencer that manages the sequence of steps within a task. The Schedule Supervisor makes individual tasks “active” at the appropriate time and adjusts the schedule if it becomes apparent that more time is required for a particular task. The Instruction Sequencer presents the current active task, providing subsequent steps as a first user progresses through the task. It can automatically alter the sequence of steps in response to problems or based on user responses.

The Activity Assistant presents information to a first user about the first user's schedule and the instructional steps to accomplish the activities in that schedule. This information is generated by the Cognition Manager. Based on this information, the Activity Assistant dynamically generates a document, which presents this information to a first user. The Activity Assistant makes this dynamically generated document available over a network. A first user can access the document on a local computer. The Activity Assistant also collects information based on a user's response and/or the passage of time, and reports this information to the Cognition Manager.

The Design Assistant allows second users to define the steps necessary to complete an activity. Second users can quickly build effective custom instructions for particular first users by defining, testing, and revising the instructions during sessions with these first users. The Design Assistant will also allow a second user to compose the first user's daily schedule.

The invention overcomes the disadvantages and other limitations of the prior art while providing numerous innovative features and advantages not offered by existing scheduling or wireless cueing systems. The advantages and features include, but are not limited, to the following examples. First, the present invention enables multiple users to access and manipulate the activity information of one of the users, enabling a second user to manage and monitor a first user's performance. Second, the present invention provides two-way interaction between a first user and the present invention allowing a first user to provide feedback about whether or not an activity step has been completed, or whether additional time or instructions are needed. Third, in addition to simple sequential presentation of instructions, instruction sets created by the Design Assistant can include branching from one instruction to another. Other advantages will be readily apparent to those skilled in the art upon reading the following detailed description and preferred embodiments.

### DETAILED DESCRIPTION OF PREFERRED EMBODIMENTS

One preferred embodiment of the present invention provides reminders and task guidance to individuals with cognitive impairments. In this embodiment, the first user is the individual with cognitive impairments and the second user is at least one of the group of a rehabilitation professional, physician or caregiver. In other embodiments, a first user is a business executive and a second user an assistant, colleague or superior. In yet another embodiment, the first user is an astronaut and the second user mission control. A first and second user could be the same individual or entity. Further, there can be multiple first and second users.

In one embodiment, the Cognition Manager and Information Server are implemented in software on a server connected to the Internet. The Activity Assistant provides reminders in the form of HTML documents, which can be accessed by standard web browsers with access to the World Wide Web. The Design Assistant is implemented as a software application on a desktop computer, which provides information on a user's scheduled tasks to the Cognition Manager via the Internet.

The Design Assistant for this embodiment provides a graphical editor for defining, viewing, and adjusting the content and ordering of the steps of an instruction as well as the presentation of the instructional steps to the user. The Design Assistant can optionally be used to manage the set of instructions available for a client, including adding and removing tasks. The user interface is designed to support both clinicians and caregivers, with and without skills in task analysis. A clinician or caregiver who is familiar with a user's typical difficulties will be able to incorporate contingency planning in the task so that users can avoid or recover more effectively from errors.

The Design Assistant for building user schedules addresses the following challenges in using automated planners: (1) understanding and influencing how plan input by the user results in a particular plan or in an inability to plan; (2) adjusting a plan based on user preferred temporal and resource constraints; (3) managing multiple versions of a plan; and (4) accessing planning information remotely.

The present invention accommodates changes in a user's needs over time. The interface is designed to allow a second user, e.g., a caregiver, clinician or manager, to edit the first user's schedule and task analyses as needed. Furthermore, the implementation has features that help the second user know what changes might be necessary. The present invention logs the first user's interaction during daily tasks. This information can be used to determine which tasks were difficult for a first user, and which were performed with ease and perhaps did not require reminders. The second user can also identify and revise instructional steps that are not effective for a first user. Second, the present invention provides a means to call for assistance from a second user. By moving from automated instruction to human assistance, the system supports learning how to adjust instructions to better support a first user.

The schedule and task structure defined using the Design Assistant is translated into an Extensible Markup Language (XML) document. The Design Assistant provides the XML document to the Information Server, which stores the schedule and task data and makes it available to the Cognition Manager. The Cognition Manager interprets this data in order to translate it into code consistent with the Activity Planner and Instruction Sequencer.

The Cognition Manager consists of a Schedule Supervisor that manages the primary user's schedule, and an Instruction Sequencer that manages the sequence of steps within a task. The Schedule Supervisor is based on the Adversarial Planner and the Instruction Sequencer is based on the RAPs reactive planner. The relationship between the Instruction Sequencer and the Schedule Supervisor resembles a Three-Tier (3T) architecture. In 3T, the Adversarial Planner passes a goal to the RAPs sequencer. The sequencer adds a task to its agenda that should accomplish that goal. When the task is removed from the agenda, the sequencer passes back status information to the planner indicating whether the goal was accomplished. The 3T architecture has previously been used for scheduling and executing control tasks in automated systems. The Cognition Manager represents the first use of a layered architecture like 3T to provide instructional assistance to humans for their activities integrated with activity scheduling.

The Cognition Manager's Instruction Sequencer, in conjunction with the Activity Assistant, presents a first user with information about scheduled tasks. When it is time for a scheduled activity to be performed, the Activity Assistant alerts a first user using a signal customized for the client (e.g., alarm tone or audio file of oral text). The Activity Assistant delivers a series of prompts to a user, corresponding to the steps in a task. These prompts are presented as dynamically generated HTML. After a first user begins to perform the task, the first user is prompted to perform each step of the task and asked to give feedback when the first user completes the step. A first user also can ask for help if an instruction is unclear. The Instruction Sequencer selects and presents subsequent steps as the first user progresses through the task, permitting both the content and the sequence of steps to be altered in response to problems or changes. If a step takes significantly longer than expected, a first user will be prompted again with an alternative step (i.e., the same step presented differently or an alternative way of performing the same step). If a first user still does not indicate that the first user has completed the step, the second user, e.g., a caregiver, can be notified to provide further assistance or the task can be abandoned.

As a first user progresses through the task, the first user's web browser remains directed to the same web address. The Activity Assistant dynamically changes the web page at this address to reflect the current step in the task as further information is provided by the Cognition Manager.

All interaction between the first user and the Activity Assistant can be logged for use by the second user in adjusting instructional sequences.

If tasks are abandoned before completion, or if a task takes significantly longer than expected, a second user can adjust a first user's schedule. When a task is abandoned, it frees up time to do other tasks on the schedule early if constraints permit. When a task takes longer, it requires making choices about what planned tasks to delay to another day based on priority information provided by the second user when a schedule is built. When the second user builds a first user's next schedule, tasks that were abandoned during the initial temporal period are reconsidered for scheduling for the next temporal period.

To provide contingency support, Solo integrates deliberative planning with plan repair for activity scheduling with reactive planning for situated instructional assistance with alternative steps. It models tasks as goal states to be achieved. Task failure occurs when a goal state is not achieved by executing the associated instruction. Schedule repair is used when tasks fail or are delayed.

Other embodiments of the invention include integration of sensor modules, which provide additional information about the first user's environment. Sensor data provides for context-sensitive reminding and automatic confirmation of instructional steps. First, the sensors indicate whether a reminder is necessary given the current state of a first user's environment and known active goals. Second, awareness of the first user's environment allows the present invention to collect information about when reminders are needed and when they are not; for example, if the system was scheduled to provide a reminder but a first user had already independently performed the task. Thus, the addition of sensors allows the present invention to recognize whether tasks have been completed and automatically provide appropriate reminders for the current situation. In some embodiments, sensors are used to confirm the completion of some instructional steps (e.g., detect when an oven is heated), reducing first user effort and improving the ability to detect and correct user errors.

In one embodiment of the system, the system is integrated into an environment equipped with environmental sensors as described above; integral means to deliver messages (e.g. speakers or video screens in the environment); and means to directly affect the environment (e.g. turning off a stove, opening a door).

Having described the presently preferred embodiments, it is to be understood that the present invention may be otherwise embodied by the scope of the appended claims.

What is claimed is:

1. A method for providing scheduling assistance and task guidance, said method including supporting an intelligent, automatic adaptation of at least:
a. a user's schedule; and
b. a task plan in response to a user's progress on tasks.

2. A system which embodies the method of claim 1, comprised of at least one component selected from the group consisting of:
a. a component that provide at least one of reminders and instructions;
b. a component that enacts automated scheduling of multiple coincident and sequential tasks;
c. a component that enacts integration of user feedback data with stored data; and
d. a component that allows for the defining of at least one of tasks and schedules while providing for data storage related to said tasks and schedules.

3. The system of claim 2, wherein said components are distributed across multiple devices via network connections.

4. The system of claim 3, wherein the component that enacts automated scheduling of multiple coincident and sequential tasks exists on a central server, and the components that: (a) provide reminders and instructions: and (b) allow for definition of tasks and schedules exist on any device having access to said central server.

5. The system of claim 4, wherein said component that provides reminders and instructions allows multiple users to receive schedules and instructions remotely on any device having access to said central server.

6. The system of claim 2, wherein said component that provides reminders and instructions dynamically generates a document for presenting said reminders and instructions to a user.

7. The system of claim 6, wherein said dynamically generated documents are HTML documents which can be accessed by standard web browsers having internet access.

8. The system of claim 2, wherein said component that allows for definition of tasks and schedules is a graphical editor for: (a) defining, viewing, and adjusting the content and ordering of steps of an instruction; and (b) presenting instructional steps to a user.

9. The system of claim 8, wherein said component allows multiple, authorized users to: (a) remotely access the schedule and instructions; and (b) build instructions and schedules.

10. The system of claim 8, wherein said component allows a user who is familiar with typical difficulties in a task performance to incorporate contingency planning in the task definition thereby allowing users to avoid or recover more effectively from errors.

11. The system of claim 2, wherein the user is able to provide feedback concerning task process and wherein the system is able to respond to said feedback by altering at least one of the task plan and schedule.

12. The system of claim 2, wherein the progress of a first user receiving task prompts from the system can be monitored by one or more secondary users.

13. The system of claim 12, wherein a secondary user can be informed of said first user's progress in a task through a user-initiated interaction that includes the second user accessing the schedule of the first user.

14. The system of claim 12, wherein a secondary user can be informed of said first user's progress in a task by a system-initiated interaction that includes the system alerting the second user of an emergency situation.

15. The system of claim 2, wherein at least one of said components that: (a) enact automated scheduling of multiple coincident and sequential tasks; and (b) enact integration of user feedback data with stored data include a schedule supervisor that: (i) manages a first user's schedule; (ii) makes an individual task active at the appropriate time; and (iii) adjusts the schedule if more time is required for a particular task.

16. The system of claim 15, wherein the system adjusts a plan based on preferred temporal and resource constraints of a user.

17. The system of claim 15, wherein tasks are modeled relative to a goal state to be achieved and a schedule repair is used when a task fails or is delayed.

18. The system of claim 2, wherein at least one of said components that: (a) enact automated scheduling of multiple coincident and sequential tasks; and (b) enact integration of user feedback data with stored data include an instruction sequencer that: (i) manages the sequence of steps within a task; (ii) presents the current active step for said task; (iii) provides subsequent steps as a first user progresses through the task; and (iv) automatically alter the sequence of steps in response to a detected problem or user inputted response.

19. The system of claim 2 which further includes one or more sensor modules for: (a) providing information about a user's environment; (b) allowing for context-sensitive reminding; and (c) automatically confirming instructional steps.

20. The system of claim 19, wherein the system is integrated into an environment equipped with: (a) said sensor modules; (b) integral means to deliver messages in the environment; and (c) means to directly affect the environment.
